(19) United States
(12) Patent Application Publication
(10) Pub. No.: US 2026/0058554 A1
(43) Pub. Date: Feb. 26, 2026

(54) VOLTAGE SUPPLY CIRCUIT

(71) Applicant: REALTEK SEMICONDUCTOR CORPORATION, Hsinchu (TW)

(72) Inventors: WEN-HAU YANG, Hsinchu (TW); Chun-Yu Luo, Hsinchu (TW); Chien-sheng Chen, Hsinchu (TW); Chih-Hao Lin, Hsinchu (TW)

(21) Appl. No.: 19/202,709

(22) Filed: May 8, 2025

(30) Foreign Application Priority Data
Aug. 20, 2024 (TW) 113131351

(51) Int. Cl. H02M 3/155

(52) U.S. Cl. CPC H02M 3/155

(57) ABSTRACT

A voltage supply circuit includes a first loop and a second loop. The first loop includes a first and second transistor, and a first and second resistor. The first resistor couples to the first transistor. The second resistor couples between the first and second transistor. The second loop includes a third and fourth transistor, and a third and fourth resistor. The third resistor and the third transistor couple at an output node for providing an output voltage. The fourth resistor couples between the third resistor and the fourth transistor. The first and third transistor couple to a high-voltage level terminal. A control terminal of the first transistor couples to that of the third transistor. The second and fourth transistor couples to a low-voltage level terminal. A control terminal of the second transistor couples to that of the fourth transistor. The first resistor to the fourth resistor include variable resistors.

### BACKGROUND OF THE INVENTION

### 1. Field of the Invention

The present disclosure relates to a voltage supply circuit, especially to a voltage supply circuit that prevents output voltage from being affected by temperature variation and load current variation through circuit design.

### 2. Description of Related Art

A typical bandgap voltage reference circuit is composed of multiple transistors. However, if the transistors are fabricated by different processes or if parameters of the transistors vary due to process drift within the same process, the reference voltage generated by the bandgap voltage reference circuit will be affected by temperature variation.

Furthermore, if the load current of the bandgap voltage reference circuit increases, the DC voltage level of the bandgap voltage reference circuit will decrease, and the temperature coefficient will diminish, thereby causing the output voltage to be influenced by both the reduction in DC voltage level and the inability to maintain the temperature coefficient.

### SUMMARY OF THE INVENTION

In some aspects, an object of the present disclosure is to, but not limited to, provides a voltage supply circuit that makes an improvement to the prior art.

An embodiment of a voltage supply circuit of the present disclosure includes a first loop and a second loop. The first loop includes a first transistor, a second transistor, a first resistor, and a second resistor. The first transistor is coupled to a high voltage level terminal. The second transistor is coupled to a low voltage level terminal. The first resistor is coupled with the first transistor at a first node. The second resistor is coupled between the first resistor and the second transistor. The first resistor and the second resistor comprise variable resistors. The second loop includes a third transistor, a fourth transistor, a third resistor, and a fourth resistor. The third transistor is coupled to the high voltage level terminal. A control terminal of the first transistor is coupled to a control terminal of the third transistor. The fourth transistor is coupled to the low voltage level terminal. A control terminal of the second transistor is coupled to a control terminal of the fourth transistor. The third resistor is coupled with the third transistor at an output node for providing an output voltage. The fourth resistor is coupled between the third resistor and the fourth transistor. The third resistor and the fourth resistor comprise variable resistors.

Technical features of some embodiments of the present disclosure make an improvement to the prior art. The voltage supply circuit of the present disclosure adopts variable resistors to adjust a slope of a temperature coefficient voltage with respect to temperature variation, such that the voltage supply circuit can maintain a zero temperature coefficient to prevent the output voltage from being affected by temperature variation. Furthermore, the voltage supply circuit of the present disclosure operates through a closed-loop control architecture formed by the first loop and the second loop to prevent the output voltage from being influenced by load current variation while maintaining the original temperature coefficient.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a voltage supply circuit of the present disclosure.

FIG. 2 shows an embodiment of an output voltage and temperature of the present disclosure.

FIG. 3 shows an embodiment of a positive temperature coefficient voltage, a negative temperature coefficient voltage, and temperature of the present disclosure.

FIG. 4 shows an embodiment of a voltage supply circuit of the present disclosure.

FIG. 5 shows an embodiment of a voltage supply circuit of the present disclosure.

FIG. 6 shows an embodiment of an output voltage and temperature of the present disclosure.

FIG. 7 shows an embodiment of a positive temperature coefficient voltage, a negative temperature coefficient voltage, and temperature of the present disclosure.

FIG. 8 shows an embodiment of a voltage supply circuit of the present disclosure.

FIG. 9 shows an embodiment of a voltage supply circuit of the present disclosure.

FIG. 10 shows an embodiment of an output voltage and temperature of the present disclosure.

FIG. 11 shows an embodiment of a positive temperature coefficient voltage, a negative temperature coefficient voltage, and temperature of the present disclosure.

FIG. 12 shows an embodiment of a voltage supply circuit of the present disclosure.

### DETAILED DESCRIPTION OF THE PREFERRED EMBODIMENTS

To address the issue in prior art that an output voltage is affected by temperature variation and load current variation, the present disclosure provides a voltage supply circuit, which will be explained in detail as shown below.

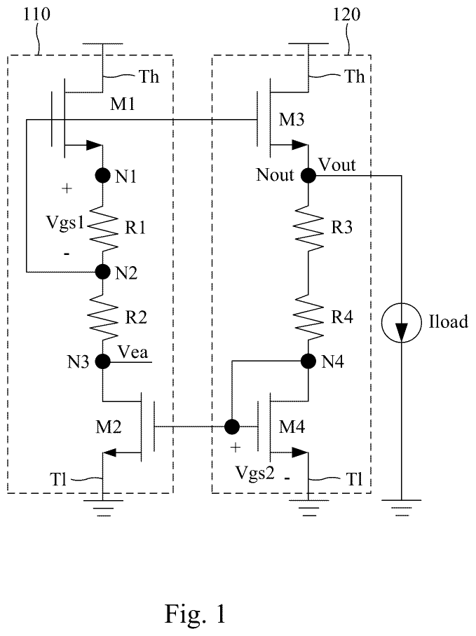

FIG. 1 shows an embodiment of a voltage supply circuit 100 of the present disclosure. As shown in the figure, the voltage supply circuit 100 includes a first loop 110 and a second loop 120. The first loop 110 includes a first transistor M1, a second transistor M2, a first resistor R1, and a second resistor R2. The second loop 120 includes a third transistor M3, a fourth transistor M4, a third resistor R3, and a fourth resistor R4.

With respect to circuit design, the first transistor M1 and the third transistor M3 are coupled to a high voltage level terminal Th. The control terminal of the first transistor M1 is coupled to the control terminal of the third transistor M3. The second transistor M2 and the fourth transistor M4 are coupled to a low voltage level terminal Tl. The control terminal of the second transistor M2 is coupled to the control terminal of the fourth transistor M4. In addition, the first resistor R1 and the first transistor M1 are coupled at a first node N1. The second resistor R2 is coupled between the first resistor R1 and the second transistor M2. The first resistor R1 and the second resistor R2 include variable resistors. The third resistor R3 and the third transistor M3 are coupled at an output node Nout for providing an output voltage Vout. The fourth resistor R4 is coupled between the third resistor R3 and the fourth transistor M4. The third resistor R3 and the fourth resistor R4 include variable resistors. The formula of the output voltage Vout provided by the voltage supply circuit 100 of the present disclosure is as follows:

$$Vout = Vgs 2 + ( \frac{\vert Vgs 1 \vert}{R 1} ) \times ( R 1 + R 2 ) \qquad formula 1$$

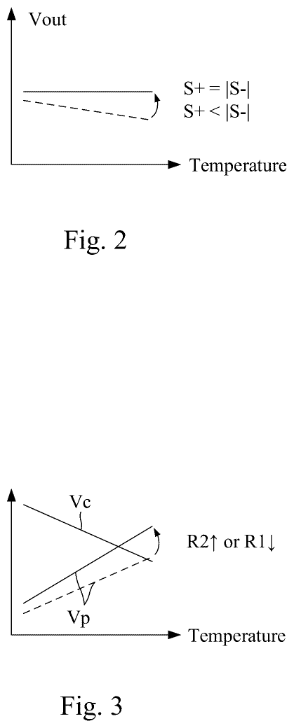

As shown in formula 1, Vout is the output voltage, Vgs1 is a voltage across the first transistor M1, Vgs2 is a voltage across the fourth transistor M4, R1 is the first resistor, and R2 is the second resistor. As shown in formula 1, FIG. 2, and FIG. 3, assuming that the output voltage V out in FIG. 2 is in a state that the slope S+ of the positive temperature coefficient voltage is less than the slope |S−| of the negative temperature coefficient voltage, the present disclosure can decrease the first resistor R1 (or the third resistor R3) or increase the second resistor R2 (or the fourth resistor R4) to enhance the slope of the positive temperature coefficient voltage Vp in FIG. 3. In this way, the output voltage Vout in FIG. 2 can return to a state that the slope S+ of the positive temperature coefficient voltage equals the slope |S−| of the negative temperature coefficient voltage, such that the voltage supply circuit 100 of the present disclosure can maintain a zero temperature coefficient, thereby preventing the output voltage V out from being affected by temperature variation.

Additionally, when the load current Iload changes, the DC voltage level of the error voltage Vea (i.e., the control terminal voltage of the first transistor M1 and the third transistor M3) will adjust accordingly, such that the DC voltage level of the cross voltage Vgs1 of the first transistor M1 remains unaffected. As a result, the DC voltage level of the output voltage Vout remains unaffected, while the original temperature coefficient is maintained. In short, the voltage supply circuit 100 of the present disclosure operates through a closed-loop control structure formed by the first loop 110 and second loop 120 to prevent the output voltage Vout from being affected by the load current Iload variation while maintaining the original temperature coefficient.

As shown in FIG. 1, in some embodiments, the first transistor M1 includes a first terminal, a control terminal, and a second terminal. The first terminal (e.g., the upper terminal) of the first transistor M1 is coupled to the high voltage level terminal Th. The second terminal (e.g., the lower terminal) of the first transistor M1 and the first terminal (e.g., the upper terminal) of the first resistor R1 are coupled at the first node N1. The control terminal of the first transistor M1 and the second terminal (e.g., the lower terminal) of the first resistor R1 are coupled at a second node N2. In some embodiments, the first terminal (e.g., the upper terminal) of the second resistor R2, the control terminal of the first transistor M1, and the second terminal (e.g., the lower terminal) of the first resistor R1 are coupled at the second node N2.

In some embodiments, the second transistor M2 includes a first terminal, a control terminal, and a second terminal. The first terminal (e.g., the upper terminal) of the second transistor M2 and the second terminal (e.g., the lower terminal) of the second resistor R2 are coupled at a third node N3 for providing the error voltage Vea. The control terminal of the second transistor M2 is coupled to the control terminal of the fourth transistor M4. The second terminal (e.g., the lower terminal) of the second transistor M2 is coupled to the low voltage level terminal Tl.

In some embodiments, the third transistor M3 includes a first terminal, a control terminal, and a second terminal. The first terminal (e.g., the upper terminal) of the third transistor M3 is coupled to the high voltage level terminal Th. The control terminal of the third transistor M3 is coupled to the control terminal of the first transistor M1. The second terminal (e.g., the lower terminal) of the third transistor M3 and the first terminal (e.g., the upper terminal) of the third resistor R3 are coupled at the output node Nout. In some embodiments, the first terminal (e.g., the upper terminal) of the fourth resistor R4 is coupled to the second terminal (e.g., the lower terminal) of the third resistor R3.

In some embodiments, the fourth transistor M4 includes a first terminal, a control terminal, and a second terminal. The first terminal (e.g., the upper terminal) of the fourth transistor M4 and the second terminal (e.g., the lower terminal) of the fourth resistor R4 are coupled at a fourth node N4. The control terminal of the fourth transistor M4, the first terminal (e.g., the upper terminal) of the fourth transistor M4, and the second terminal (e.g., the lower terminal) of the fourth resistor R4 are coupled at the fourth node N4, and the control terminal of the fourth transistor M4 is coupled to the control terminal of the second transistor M2. The second terminal (e.g., the lower terminal) of the fourth transistor M4 is coupled to the low voltage level terminal Tl.

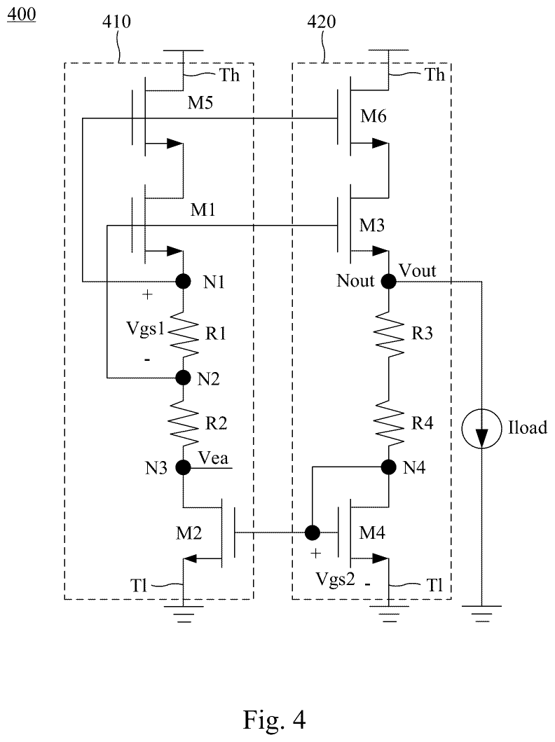

FIG. 4 shows an embodiment of a voltage supply circuit 400 of the present disclosure. Compared to the voltage supply circuit 100 in FIG. 1, the first loop 410 of the voltage supply circuit 400 in FIG. 4 further includes a fifth transistor M5, and the second loop 420 further includes a sixth transistor M6. The fifth transistor M5 is coupled between a high voltage level terminal Th and the first transistor M1, and the control terminal of the fifth transistor M5 is coupled to the second terminal (e.g., the lower terminal) of the first transistor M1. In addition, the sixth transistor M6 is coupled between the high voltage level terminal Th and the third transistor M3, and the control terminal of the sixth transistor M6 is coupled to the control terminal of the fifth transistor M5.

When the DC voltage level of the input voltage undergoes significant variations, the DC voltage level of the output voltage V out tends to be affected. The effect is referred to as line regulation. To improve line regulation, the voltage supply circuit 400 of the present disclosure connects the first transistor M1 and the third transistor M3 in series with the fifth transistor M5 and the sixth transistor M6. Both the fifth transistor M5 and the sixth transistor M6 have negative threshold voltages, which are achieved by self-biasing. Specifically, the source of the first transistor M1 is coupled to the control terminals of the fifth transistor M5 and the sixth transistor M6. In this way, when the supply voltage exceeds the sum of the output voltage Vout and the cross voltage Vgs1 of the first transistor M1, the drain-source cross voltage of the first transistor M1 and the third transistor M3 can still be maintained at approximately the DC voltage level of the cross voltage Vgs1 of the first transistor M1, thereby improving line regulation.

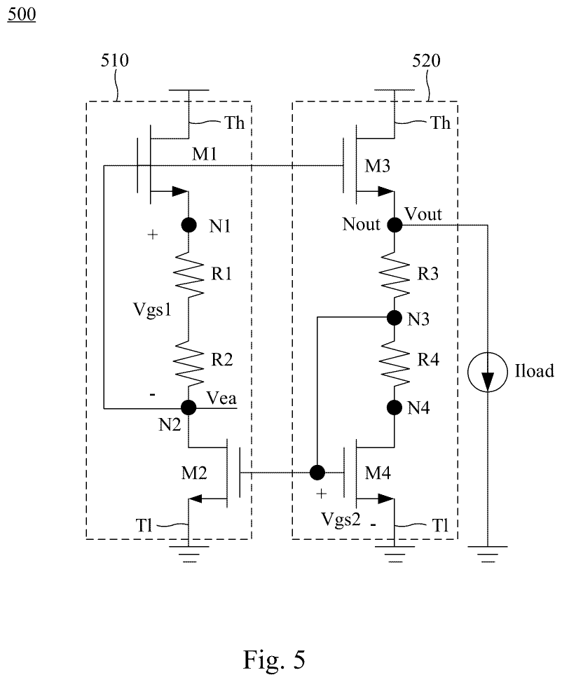

FIG. 5 shows an embodiment of a voltage supply circuit 500 of the present disclosure. As shown in the figure, the voltage supply circuit 500 includes a first loop 510 and a second loop 520. The first loop 510 includes a first transistor M1, a second transistor M2, a first resistor R1, and a second resistor R2. The second loop 520 includes a third transistor M3, a fourth transistor M4, a third resistor R3, and a fourth resistor R4.

With respect to circuit design, the first transistor M1 and the third transistor M3 are coupled to a high voltage level terminal Th. The control terminal of the first transistor M1 is coupled to the control terminal of the third transistor M3. The second transistor M2 and the fourth transistor M4 are coupled to a low voltage level terminal Tl. The control terminal of the second transistor M2 is coupled to the control terminal of the fourth transistor M4. In addition, the first resistor R1 and the first transistor M1 are coupled at a first node N1. The second resistor R2 is coupled between the first resistor R1 and the second transistor M2. The first resistor R1 and the second resistor R2 include variable resistors. The third resistor R3 and the third transistor M3 are coupled at an output node Nout for providing an output voltage Vout. The fourth resistor R4 is coupled between the third resistor R3 and the fourth transistor M4. The third resistor R3 and the fourth resistor R4 include variable resistors. The formula of the output voltage Vout provided by the voltage supply circuit 500 of the present disclosure is as follows:

$$Vout = Vgs 2 + ( \frac{\vert Vgs 1 \vert}{( R 1 + R 2 )} ) \times R 2 \qquad formula 2$$

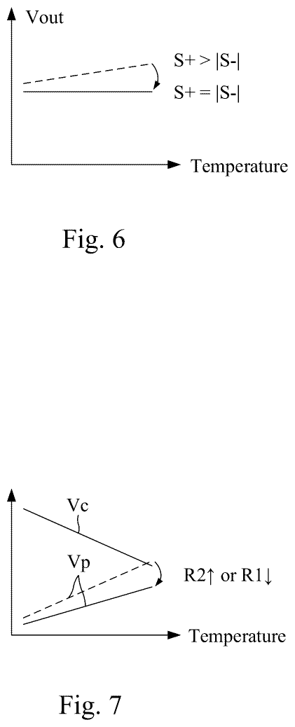

As shown in formula 2, Vout is the output voltage, Vgs1 is a voltage across the first transistor M1, Vgs2 is a voltage across the fourth transistor M4, R1 is the first resistor, and R2 is the second resistor. As shown in formula 2, FIG. 6, and FIG. 7, assuming that the output voltage V out in FIG. 6 is in a state that the slope S+ of the positive temperature coefficient voltage is larger than the slope |S−| of the negative temperature coefficient voltage, the present disclosure can decrease the first resistor R1 (or the third resistor R3) or increase the second resistor R2 (or the fourth resistor R4) to reduce the slope of the positive temperature coefficient voltage Vp in FIG. 7. In this way, the output voltage Vout in FIG. 6 can return to a state that the slope S+ of the positive temperature coefficient voltage equals the slope |S−| of the negative temperature coefficient voltage, such that the voltage supply circuit 500 of the present disclosure can maintain a zero temperature coefficient, thereby preventing the output voltage V out from being affected by temperature variation.

In addition, when the load current Iload changes, the DC voltage level of the error voltage Vea (i.e., the control terminal voltage of the first transistor M1 and the third transistor M3) will adjust accordingly, such that the DC voltage level of a cross voltage Vgs1 of the first transistor M1 remains unaffected. As a result, the DC voltage level of the output voltage V out remains unaffected, while the original temperature coefficient is maintained. In short, the voltage supply circuit 500 of the present disclosure operates through a closed-loop control structure formed by the first loop 510 and the second loop 520 to prevent the output voltage Vout from being affected by the load current Iload variation while maintaining the original temperature coefficient.

As shown in FIG. 5, in some embodiments, the first transistor M1 includes a first terminal, a control terminal, and a second terminal. The first terminal (e.g., the upper terminal) of the first transistor M1 is coupled to the high voltage level terminal Th. The second terminal (e.g., the lower terminal) of the first transistor M1 and the first terminal (e.g., the upper terminal) of the first resistor R1 are coupled at the first node N1. The control terminal of the first transistor M1 and the first terminal (e.g., the lower terminal) of the second resistor R2 are coupled at the second node N2. In some embodiments, the second terminal (e.g., the upper terminal) of the second resistor R2 is coupled to the second terminal (e.g., the lower terminal) of the first resistor R1.

In some embodiments, the second transistor M2 includes a first terminal, a control terminal, and a second terminal. The first terminal (e.g., the upper terminal) of the second transistor M2, the control terminal of the first transistor M1, and the first terminal (e.g., the lower terminal) of the second resistor R2 are coupled at a second node N2. The control terminal of the second transistor M2 is coupled to the control terminal of the fourth transistor M4. The second terminal (e.g., the lower terminal) of the second transistor M2 is coupled to the low voltage level terminal Tl.

In some embodiments, the third transistor M3 includes a first terminal, a control terminal, and a second terminal. The first terminal (e.g., the upper terminal) of the third transistor M3 is coupled to the high voltage level terminal Th. The control terminal of the third transistor M3 is coupled to the control terminal of the first transistor M1. The second terminal (e.g., the lower terminal) of the third transistor M3 and the first terminal (e.g., the upper terminal) of the third resistor R3 are coupled at the output node Nout. In some embodiments, the first terminal (e.g., the upper terminal) of the fourth resistor R4 and the second terminal (e.g., the lower terminal) of the third resistor R3 are coupled at a third node N3.

In some embodiments, the fourth transistor M4 includes a first terminal, a control terminal, and a second terminal. The first terminal (e.g., the upper terminal) of the fourth transistor M4 and the second terminal (e.g., the lower terminal) of the fourth resistor R4 are coupled at a fourth node N4. The control terminal of the fourth transistor M4, the second terminal (e.g., the lower terminal) of the third resistor R3, and the first terminal (e.g., the upper terminal) of the fourth resistor R4 are coupled at the third node N3, and the control terminal of the fourth transistor M4 is coupled to the control terminal of the second transistor M2. The second terminal (e.g., the lower terminal) of the fourth transistor M4 is coupled to the low voltage level terminal Tl.

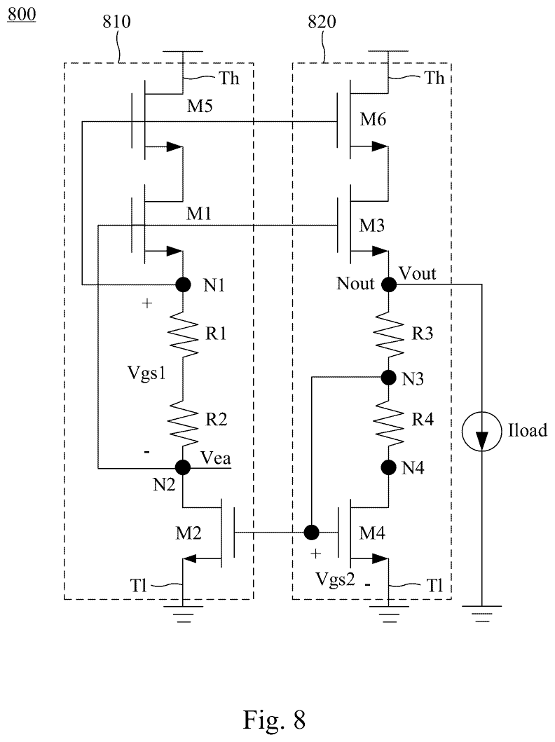

FIG. 8 shows an embodiment of a voltage supply circuit 800 of the present disclosure. Compared to the voltage supply circuit 500 in FIG. 5, the first loop 810 of the voltage supply circuit 800 in FIG. 8 further includes a fifth transistor M5, and the second loop 820 further includes a sixth transistor M6. The fifth transistor M5 is coupled between a high voltage level terminal Th and the first transistor M1, and the control terminal of the fifth transistor M5 is coupled to the second terminal (e.g., the lower terminal) of the first transistor M1. In addition, the sixth transistor M6 is coupled between the high voltage level terminal Th and the third transistor M3, and the control terminal of the sixth transistor M6 is coupled to the control terminal of the fifth transistor M5.

When the DC voltage level of the input voltage undergoes significant variations, the DC voltage level of the output voltage Vout tends to be affected. This effect is referred to as line regulation. To improve line regulation, the voltage supply circuit 800 of the present disclosure connects the first transistor M1 and the third transistor M3 in series with the fifth transistor M5 and the sixth transistor M6. Both the fifth transistor M5 and the sixth transistor M6 have negative threshold voltages, which are achieved through self-biasing. Specifically, the source of the first transistor M1 is coupled to the control terminals of the fifth transistor M5 and the sixth transistor M6. In this way, when the supply voltage exceeds the sum of the output voltage Vout and the cross voltage Vgs1 of the first transistor M1, the drain-source cross voltage of the first transistor M1 and the third transistor M3 can still be maintained at approximately the DC voltage level of the cross voltage Vgs1 of the first transistor M1, thereby improving line regulation.

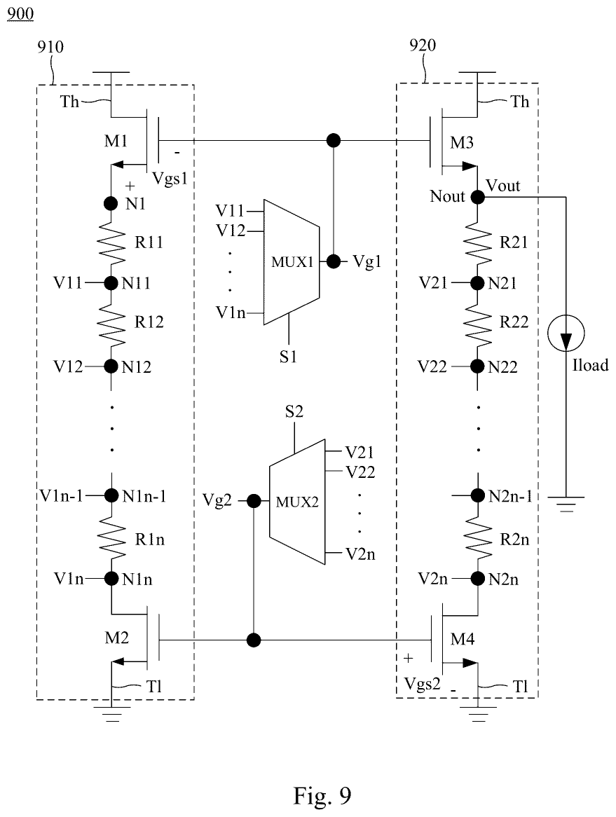

As shown in FIG. 9, in some embodiments, the first loop 910 of the voltage supply circuit 900 further includes a plurality of first loop resistors R11˜R1n, and the plurality of first loop resistors R11˜R1n are coupled in pairs and in series at a plurality of first loop nodes N11˜N1n. For example, the first loop resistor R11 and the first loop resistor R12 are coupled in series at the first loop node N11.

In some embodiments, the first transistor M1 includes a first terminal, a control terminal, and a second terminal. The first terminal (e.g., the upper terminal) of the first transistor M1 is coupled to a high voltage level terminal Th. The control terminal of the first transistor M1 is coupled to the control terminal of the third transistor M3. The second terminal (e.g., the lower terminal) of the first transistor M1 and the first terminal (e.g., the upper terminal) of the resistor R11 of the plurality of first loop resistors R11˜R1n are coupled at the first node N1.

In some embodiments, the voltage supply circuit 900 further includes a first multiplexer MUX1. The first multiplexer MUX1 includes a first terminal and a second terminal. The first terminal (e.g., the right terminal) of the first multiplexer MUX1 is coupled to the control terminal of the first transistor M1 and the control terminal of the third transistor M3. The second terminal (e.g., the left terminal) of the first multiplexer MUX1 is selectively coupled to one of the plurality of first loop nodes N1˜N1n. In some embodiments, the second terminal (e.g., the left terminal) of the first multiplexer MUX1 is coupled to one of the plurality of first loop nodes N1˜N1n according to a first selection signal S1. In some embodiments, the plurality of first loop resistors R11˜R1n can be selectively coupled to the control terminals of the first transistor M1 and the third transistor M3 through the first loop nodes N11˜N1n, thereby forming different resistor values. In some embodiments, each of the plurality of first loop resistors R11˜R1n may have the same resistor value, or each of the plurality of first loop resistors R11˜R1n may have different resistor values. In some embodiments, the voltage supply circuit 900 of the present disclosure can adjust the node to which the control terminals of the first transistor M1 and the third transistor M3 are connected through the first multiplexer MUX1. Taking the first transistor M1 as an example, the formula of the voltage of the control terminal of the first transistor M1 is as follows:

$$Vg 1 = Vk 1 \qquad formula 3$$

As shown in formula 3, Vg1 is the voltage of the control terminal of the first transistor M1. Vk1 depends on the node to which the first multiplexer MUX1 is connected. For example, if the first multiplexer MUX1 is connected to the first loop node N11, Vk1 is V11, and if the first multiplexer MUX1 is connected to the first loop node N12, Vk1 is V12, and so on. k1 ranges from 1 to N.

In some embodiments, the second transistor M2 includes a first terminal, a control terminal, and a second terminal. The first terminal (e.g., the upper terminal) of the second transistor M2 and the resistor Rin are coupled atone of the plurality of first loop nodes (e.g., the node N in). The control terminal of the second transistor M2 is coupled to the control terminal of the fourth transistor M4. The second terminal (e.g., the lower terminal) of the second transistor M2 is coupled to a low voltage level terminal Tl.

In some embodiments, the second loop 920 of the voltage supply circuit 900 further includes a plurality of second loop resistors R21˜R2n, and the plurality of second loop resistors R21˜R2n are coupled in pairs and in series at a plurality of second loop nodes N21˜N2n. For example, the second loop resistor R21 and the second loop resistor R22 are coupled in series at the second loop node N21.

In some embodiments, the voltage supply circuit 900 further includes a second multiplexer MUX2. The second multiplexer MUX2 includes a first terminal and a second terminal. The first terminal (e.g., the left terminal) of the second multiplexer MUX2 is coupled to the control terminal of the second transistor M2 and the control terminal of the fourth transistor M4. The second terminal (e.g., the right terminal) of the second multiplexer MUX2 is selectively coupled to one of the plurality of second loop nodes N21˜N2n. In some embodiments, the second terminal (e.g., the right terminal) of the second multiplexer MUX2 is coupled to one of the plurality of second loop nodes N21˜N2n according to a second selection signal S2. In some embodiments, the plurality of second loop resistors R21˜R2n can be selectively coupled to the control terminals of the second transistor M2 and the fourth transistor M4 through the second loop nodes N21˜N2n, thereby forming different resistor values. In some embodiments, each of the plurality of second loop resistors R21˜R2n may have the same resistance value, or each of the plurality of second loop resistors R21˜R2n may have different resistance values. In some embodiments, the voltage supply circuit 900 of the present disclosure can adjust the node to which the control terminals of the second transistor M2 and the fourth transistor M4 are connected through the second multiplexer MUX2. Taking the second transistor M2 as an example, the formula of the voltage of the control terminal of the second transistor M2 is as follows:

$$Vg 2 = Vk 2 \qquad formula 4$$

As shown in formula 4, Vg2 is the voltage of the control terminal of the second transistor M2, and Vk2 depends on the node to which the second multiplexer MUX2 is connected. For example, if the second multiplexer MUX2 is connected to the second loop node N21, Vk2 is the V21, and if the second multiplexer MUX2 is connected to the second loop node N22, Vk2 is the V22, and so on. k2 ranges from 1 to N.

The formula of the output voltage V out provided by the voltage supply circuit 900 of the present disclosure is as follows:

$$Vout = Vgs 2 + ( \frac{\vert Vgs 1 \vert}{k 1 \times R} ) \times ( k 2 \times R ) \qquad formula 5$$

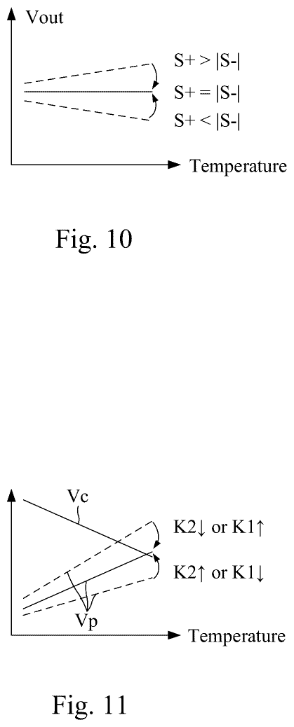

As shown in formula 5, Vout is the output voltage, Vgs1 is a voltage across the first transistor M1, Vgs2 is a voltage across the fourth transistor M4, and k1 and k2 depend on the nodes to which the first multiplexer MUX1 and the second multiplexer MUX2 are connected. As shown in formula 5, FIG. 10, and FIG. 11, assuming that the output voltage V out in FIG. 10 is in a state that the slope S+ of the positive temperature coefficient voltage is larger than the slope |S−| of the negative temperature coefficient voltage, the present disclosure can decrease the ratio of to reduce the slope of the positive temperature coefficient voltage Vp in FIG. 11. In this way, the output voltage Vout in FIG. 10 can return to a state that the slope S+ of the positive temperature coefficient voltage equals the slope |S−| of the negative temperature coefficient voltage, such that the voltage supply circuit 900 of the present disclosure can maintain a zero temperature coefficient, thereby preventing the output voltage V out from being affected by temperature variation.

In addition, assuming that the output voltage Vout in FIG. 10 is in a state that the slope S+ of the positive temperature coefficient voltage is less than the slope |S−| of the negative temperature coefficient voltage, the present disclosure can increase the ratio of to enhance the slope of the positive temperature coefficient voltage V p in FIG. 11. In this way, the output voltage Vout in FIG. 10 can return to a state where the slope S+ of the positive temperature coefficient voltage equals the slope |S−| of the negative temperature coefficient voltage, such that the voltage supply circuit 900 of the present disclosure maintains a zero temperature coefficient, thereby preventing the output voltage Vout from being affected by temperature variation.

In some embodiments, the third transistor M3 includes a first terminal, a control terminal, and a second terminal. The first terminal (e.g., the upper terminal) of the third transistor M3 is coupled to the high voltage level terminal Th. The control terminal of the third transistor M3 is coupled to the control terminal of the first transistor M1. The second terminal (e.g., the lower terminal) of the third transistor M3 and the first terminal (e.g., the upper terminal) of the resistor R21 are coupled at the output node N out.

In some embodiments, the fourth transistor M4 includes a first terminal, a control terminal, and a second terminal. The first terminal (e.g., the upper terminal) of the fourth transistor M4 and the resistor R2n are coupled at the second loop node N2n. The control terminal of the fourth transistor M4 is coupled to the control terminal of the second transistor M2. The second terminal (e.g., the lower terminal) of the fourth transistor M4 is coupled to the low voltage level terminal Tl.

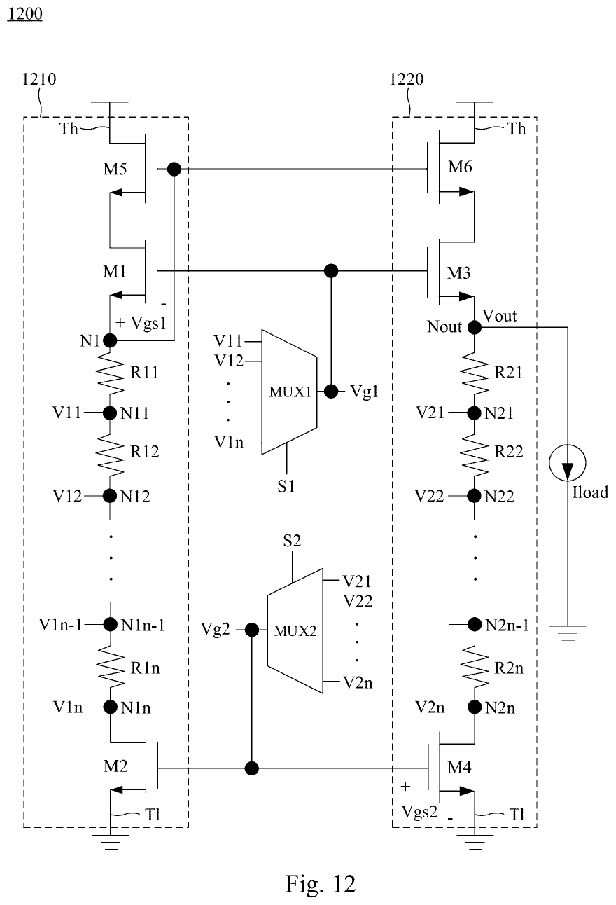

FIG. 12 shows an embodiment of a voltage supply circuit 1200 of the present disclosure. Compared to the voltage supply circuit 900 in FIG. 9, the first loop 1210 of the voltage supply circuit 1200 in FIG. 12 further includes a fifth transistor M5, and the second loop 1220 further includes a sixth transistor M6. The fifth transistor M5 is coupled between a high voltage level terminal Th and the first transistor M1, and the control terminal of the fifth transistor M5 is coupled to the second terminal (e.g., the lower terminal) of the first transistor M1. In addition, the sixth transistor M6 is coupled between the high voltage level terminal Th and the third transistor M3, and the control terminal of the sixth transistor M6 is coupled to the control terminal of the fifth transistor M5.

When the DC voltage level of the input voltage undergoes significant variations, the DC voltage level of the output voltage Vout tends to be affected. This effect is referred to as line regulation. To improve line regulation, the voltage supply circuit 1200 of the present disclosure connects the first transistor M1 and the third transistor M3 in series with the fifth transistor M5 and the sixth transistor M6. Both the fifth transistor M5 and the sixth transistor M6 have negative threshold voltages, which are achieved through self-biasing. Specifically, the source of the first transistor M1 is coupled to the control terminals of the fifth transistor M5 and the sixth transistor M6. In this way, when the supply voltage exceeds the sum of the output voltage Vout and the cross voltage Vgs1 of the first transistor M1, the drain-source cross voltage of the first transistor M1 and the third transistor M3 can still be maintained at approximately the DC voltage level of the cross voltage Vgs1 of the first transistor M1, thereby improving line regulation.

In some embodiments, as shown in FIG. 1, FIG. 4, FIG. 5, FIG. 8, FIG. 9, and FIG. 12, the first transistor M1, the second transistor M2, the third transistor M3, and the fourth transistor M4 can be Metal-Oxide-Semiconductor Field-Effect Transistors (MOSFETs). In some embodiments, the first transistor M1, the second transistor M2, the third transistor M3, and the fourth transistor M4 can be N-type MOSFETs or P-type MOSFETs. In some embodiments, the first terminal can be a drain, the control terminal can be a gate, and the second terminal can be a source.

It should be noted that the present disclosure is not limited to the embodiments as shown in FIG. 1 to FIG. 12, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The voltage supply circuit of the present disclosure adopts variable resistors to adjust a slope of a temperature coefficient voltage with respect to temperature variation, such that the voltage supply circuit can maintain a zero temperature coefficient to prevent the output voltage from being affected by temperature variation. Furthermore, the voltage supply circuit operates through a closed-loop control architecture formed by the first loop and the second loop to prevent the output voltage from being influenced by load current variation while maintaining the original temperature coefficient.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A voltage supply circuit, comprising:
a first loop, comprising:
a first transistor, coupled to a high voltage level terminal;
a second transistor, coupled to a low voltage level terminal;
a first resistor, coupled with the first transistor at a first node; and
a second resistor, coupled between the first resistor and the second transistor, wherein the first resistor and the second resistor comprise variable resistors; and
a second loop, comprising:
a third transistor, coupled to the high voltage level terminal, wherein a control terminal of the third transistor is coupled to a control terminal of the first transistor;
a fourth transistor, coupled to the low voltage level terminal, and a control terminal of the fourth transistor is coupled to a control terminal of the second transistor;
a third resistor, coupled with the third transistor at an output node for providing an output voltage; and
a fourth resistor, coupled between the third resistor and the fourth transistor, wherein the third resistor and the fourth resistor comprise variable resistors.

2. The voltage supply circuit of claim 1, wherein the first transistor comprises:
a first terminal, coupled to the high voltage level terminal;
a second terminal, coupled with a first terminal of the first resistor at the first node; and
a control terminal, coupled with a second terminal of the first resistor at a second node;
wherein a first terminal of the second resistor, the control terminal of the first transistor, and the second terminal of the first resistor are coupled at the second node.

3. The voltage supply circuit of claim 2, wherein the second transistor comprises:
a first terminal, coupled with a second terminal of the second resistor at a third node for providing an error voltage;
a control terminal, coupled to the control terminal of the fourth transistor; and
a second terminal, coupled to the low voltage level terminal.

4. The voltage supply circuit of claim 3, wherein the third transistor comprises:
a first terminal, coupled to the high voltage level terminal;
a control terminal, coupled to the control terminal of the first transistor; and
a second terminal, coupled with a first terminal of the third resistor at the output node;
wherein a first terminal of the fourth resistor is coupled to a second terminal of the third resistor.

5. The voltage supply circuit of claim 4, wherein the fourth transistor comprises:
a first terminal, coupled with a second terminal of the fourth resistor at a fourth node;
a control terminal, coupled with the first terminal of the fourth transistor and the second terminal of the fourth resistor at the fourth node, and coupled to the control terminal of the second transistor; and
a second terminal, coupled to the low voltage level terminal.

6. The voltage supply circuit of claim 5, wherein the first loop further comprises:
a fifth transistor, coupled between the high voltage level terminal and the first transistor, and a control terminal of the fifth transistor is coupled to the second terminal of the first transistor;
wherein the second loop further comprises:
a sixth transistor, coupled between the high voltage level terminal and the third transistor, wherein a control terminal of the sixth transistor is coupled to the control terminal of the fifth transistor.

7. The voltage supply circuit of claim 1, wherein the first transistor comprises:
a first terminal, coupled to the high voltage level terminal;
a second terminal, coupled with a first terminal of the first resistor at the first node; and
a control terminal, coupled with a first terminal of the second resistor at a second node;
wherein a second terminal of the second resistor is coupled to a second terminal of the first resistor.

8. The voltage supply circuit of claim 7, wherein the second transistor comprises:
a first terminal, coupled with the control terminal of the first transistor and the first terminal of the second resistor at the second node;
a control terminal, coupled to the control terminal of the fourth transistor; and
a second terminal, coupled to the low voltage level terminal.

9. The voltage supply circuit of claim 8, wherein the third transistor comprises:
a first terminal, coupled to the high voltage level terminal;
a control terminal, coupled to the control terminal of the first transistor; and
a second terminal, coupled with a first terminal of the third resistor at the output node;
wherein a first terminal of the fourth resistor and a second terminal of the third resistor are coupled at a third node.

10. The voltage supply circuit of claim 9, wherein the fourth transistor comprises:
a first terminal, coupled with a second terminal of the fourth resistor at a fourth node;
a control terminal, coupled with the second terminal of the third resistor and the first terminal of the fourth resistor at the third node, and coupled to the control terminal of the second transistor; and
a second terminal, coupled to the low voltage level terminal.

11. The voltage supply circuit of claim 10, wherein the first loop further comprises:
a fifth transistor, coupled between the high voltage level terminal and the first transistor, wherein a control terminal of the fifth transistor is coupled to the second terminal of the first transistor;
wherein the second loop further comprises:
a sixth transistor, coupled between the high voltage level terminal and the third transistor, wherein a control terminal of the sixth transistor is coupled to the control terminal of the fifth transistor.

12. The voltage supply circuit of claim 1, wherein the first loop further comprises:
a plurality of first loop resistors, coupled in pairs and in series at a plurality of first loop nodes, wherein the plurality of first loop resistors comprise the first resistor and the second resistor.

13. The voltage supply circuit of claim 12, wherein the first transistor comprises:
a first terminal, coupled to the high voltage level terminal;
a control terminal, coupled to the control terminal of the third transistor; and
a second terminal, coupled with a first terminal of the first resistor of the plurality of first loop resistors at the first node.

14. The voltage supply circuit of claim 13, further comprising:
a first multiplexer, comprising:
a first terminal, coupled to the control terminal of the first transistor and the control terminal of the third transistor; and
a second terminal, selectively coupled to one of the plurality of first loop nodes.

15. The voltage supply circuit of claim 14, wherein the second transistor comprises:
a first terminal, coupled with the second resistor at one of the plurality of first loop nodes;
a control terminal, coupled to the control terminal of the fourth transistor; and
a second terminal, coupled to the low voltage level terminal.

16. The voltage supply circuit of claim 15, further comprising:
a plurality of second loop resistors, coupled in pairs and in series at a plurality of second loop nodes, wherein the plurality of second loop resistors comprise the third resistor and the fourth resistor.

17. The voltage supply circuit of claim 16, further comprising:
a second multiplexer, comprising:
a first terminal, coupled to the control terminal of the second transistor and the control terminal of the fourth transistor; and
a second terminal, selectively coupled to one of the plurality of second loop node.

18. The voltage supply circuit of claim 17, wherein the third transistor comprises:
a first terminal, coupled to the high voltage level terminal;
a control terminal, coupled to the control terminal of the first transistor; and
a second terminal, coupled with a first terminal of the third resistor of the plurality of second loop resistors at the output node.

19. The voltage supply circuit of claim 18, wherein the fourth transistor comprises:
a first terminal, coupled with the fourth resistor at one of the plurality of second loop nodes;
a control terminal, coupled to the control terminal of the second transistor; and
a second terminal, coupled to the low voltage level terminal.

20. The voltage supply circuit of claim 19, wherein the first loop further comprises:
a fifth transistor, coupled between the high voltage level terminal and the first transistor, wherein a control terminal of the fifth transistor is coupled to the second terminal of the first transistor;
wherein the second loop further comprises:
a sixth transistor, coupled between the high voltage level terminal and the third transistor, wherein a control terminal of the sixth transistor is coupled to the control terminal of the fifth transistor.
